(19) United States
(12) Patent Application Publication
(10) Pub. No.: US 2013/0091565 A1
(43) Pub. Date: Apr. 11, 2013

(54) Access Control for Electrical Charging Stations

(71) Applicant: Gerald Käfer, Munchen (DE)

(72) Inventor: Gerald Käfer, Munchen (DE)

(21) Appl. No.: 13/702,941

(22) PCT Filed: May 13, 2011
(86) PCT No.: PCT/EP2011/057768

§ 371 Date: Dec. 7, 2012

(30) Foreign Application Priority Data
Jun. 9, 2010 (DE) 10 2010 023 127.4

(51) Int. Cl. G06F 21/00

(52) U.S. Cl. CPC G06F 21/00
USPC 726/21

(57) ABSTRACT

A method for access control and session control of electrical producers and/or consumers in accessible energy transfer units is provided, wherein the producer or the consumer is authenticated and authorized at the energy transfer unit, and producer- or consumer-specific data are forwarded by the energy transfer unit to an energy provider after authentication and authorization of the producer or the consumer. A temporarily-valid session token is generated for the control of the energy transfer by the energy provider, and forwarded to the energy transfer unit and the producer or the consumer. Electrical energy is transferred between the energy transfer unit and the producer or the consumer, wherein in a defined time interval during the energy transfer process the session token is sent at least once by the energy transfer unit to the producer or the consumer and from the producer or the consumer to the energy transfer unit.

### CROSS-REFERENCE TO RELATED APPLICATIONS

This application is a U.S. National Stage Application of International Application No. PCT/EP2011/057768 filed May 13, 2011, which designates the United States of America, and claims priority to DE Patent Application No. 10 2010 023 127.4 filed Jun. 9, 2010 The contents of which are hereby incorporated by reference in their entirety.

### TECHNICAL FIELD

The disclosure relates to a method for access and session control of electrical consumers (loads) and producers at publicly accessible or communally accessible energy access units, such as e.g. electrical charging stations for electric vehicles. The disclosure further relates to an arrangement for access and session control of electrical consumer devices at publicly accessible or communally accessible energy access units. The disclosure further relates to a corresponding energy access control unit.

### BACKGROUND

The current trend indicates that electric drives for vehicles of all kinds will achieve widespread popularity. A necessary criterion in this respect is adequate availability of charging stations. Because energy is expensive, access control and measuring or billing for the energy delivered will be assume huge importance.

Systems and devices for controlled and monitored charging of electric vehicles are known (see e.g. US patent application US2009/0174365A1), but these systems are elaborate in respect of the access control, since additional access hardware is required, such as RFID readers, cameras, etc.

### SUMMARY

In one embodiment, a method for access and session control of electrical producers and/or consumers at publicly accessible or communally accessible energy access or transfer units, said method comprising: (a) authenticating and authorizing the producer or consumer at the energy access unit by data exchange between the energy access unit and an energy provider; (b) generating a session token for the monitoring and control of an energy transfer by the energy provider and forwarding of the session token to the energy access unit and the producer or consumer, the session token having a time-limited validity; (c) after successful authentication and authorization of the producer or consumer: forwarding of producer-specific or consumer-specific data to an energy provider by the energy access unit; and (d) transferring electrical energy between the energy access unit and the producer or consumer, the session token being in each case sent in a defined time interval during the energy transfer process at least once from the energy access unit to the producer or consumer, and from the producer or consumer to the energy access unit.

In a further embodiment, the consumer is authenticated and authorized at the energy access unit by means of a standard IT access control mechanism. In a further embodiment, PKI (public key infrastructure) with smartcard is used as the access control mechanism. In a further embodiment, rules for the energy transfer are provided for the energy access unit by the energy provider. In a further embodiment, each time before being sent the session token is updated by the energy access unit or by the producer/consumer. In a further embodiment, the communication between the producer or consumer and the energy access unit takes place by means of power line communication. In a further embodiment, a local initial session token is generated by the energy access control unit and transmitted to the producer or consumer, the producer or consumer transmitting said initial session token to the energy provider, and the energy provider thereupon generating a session token for the corresponding energy access unit and the corresponding energy transfer and sending the same back to the producer or consumer, the initial session token containing identification information for the energy access unit and the session token containing the released energy quantity.

In a further embodiment, the producer or consumer is an electric vehicle and the energy access unit is a charging device for charging batteries or accumulators or is suitable for feeding energy from electric vehicles into an energy network of an energy provider. In a further embodiment, the consumer is a washing machine, a laundry dryer or another commercial electrical appliance. In a further embodiment, the producer is a photovoltaic system, a wind turbine or another alternative energy source which can be temporarily connected to the energy access unit. In a further embodiment, the energy transfer is stopped if the session token is not updated and exchanged between producer and consumer in the defined interval. In a further embodiment, the session token is used to exchange dynamic demand or capacity information for the monitoring and control of the energy flow between producer or consumer and the energy access unit.

In another embodiment, an arrangement is provided for access and session control of electrical producer or consumer devices at publicly accessible or communally accessible sockets with upstream energy access units, said arrangement comprising: (a) an energy access unit by means of which a consumer device can draw electrical energy or, as producer, can feed in energy, wherein authentication and authorization of the producer or consumer device takes place at the energy access unit by means of a standard IT access control mechanism and IT services, wherein following completion of authentication and authorization of the producer or consumer device, consumer-specific data is forwarded to an energy provider by the energy access unit, wherein electrical energy is transferred between the energy access unit and the producer or consumer device at the energy access unit as long as a session token provided by the energy provider is in each case sent at least once in a defined time interval from the energy access unit to the producer or consumer device, and from the producer or consumer device to the energy access unit; and (b) an energy provider which supplies the energy access unit with electrical energy or receives energy fed in by the producer device, wherein the energy provider, after successful authentication and authorization of the producer or consumer device, generates a session token and forwards the same to the energy access unit.

In another embodiment, an energy access control unit is provided for access and session control of electrical producer or consumer devices at publicly accessible or communally accessible energy access units by means of which a consumer device can draw electrical energy or a producer device can feed in energy; wherein authentication and authorization of the consumer device by the energy access unit takes place by means of a standard IT access control mechanism, wherein upon completion of authentication and authorization of the producer or consumer device by the energy access control unit, consumer-specific data is forwarded to an energy provider, wherein, during a charging process, electrical energy for the consumer device is provided at the energy access unit or is fed in by the producer device as long as a session token provided by the energy provider is in each case sent at least once in a defined time interval from the energy access control unit to the producer or consumer device, and from the producer or consumer device to the energy access control unit.

In a further embodiment, a local initial session token is generated by the energy access control unit and transmitted to the producer or consumer, wherein the producer or consumer forwards said initial session token to the energy provider and the energy provider thereupon generates a session token for the corresponding energy access unit and the corresponding energy transfer, and sends the same back to the producer or consumer, wherein the initial session token contains identification information for the energy access unit and the session token contains the released energy quantity.

### BRIEF DESCRIPTION OF THE DRAWINGS

Example embodiments will be explained in more detail below with reference to figures, in which:

FIG. 1 shows by way of example a schematic overview diagram with system components and energy transfer and communication relationships between the system components,

FIG. 2 shows by way of example a schematic diagram of an energy access control unit, and

FIG. 3 shows by way of example a schematic diagram of a charging and metering device.

### DETAILED DESCRIPTION

Some embodiments provide an economical method for access and session control of electrical producers and/or consumers at publicly accessible or communally accessible energy transfer stations.

For example, a method is provided for access and session control of electric producers and/or consumers at publicly accessible or communally accessible energy access or transfer units (EZEs), said method comprising:

a) authenticating and authorizing the producer or consumer at the energy access unit through integration of the energy provider;
b) generating a session token for the control of the energy transfer by the energy provider and forwarding the session token to the energy access unit and the producer and/or consumer, the session token having a time-limited validity;
c) after successful authentication and authorization of the producer and/or consumer: forwarding producer-specific or consumer-specific data to an energy provider by the energy access unit;
d) transferring electrical energy between the energy access unit and the producer and/or consumer, the session token being in each case sent in a defined time interval during the energy transfer process at least once from the energy access unit to the producer or consumer, and from the producer or consumer to the energy access unit.

A possible advantage of some embodiments is that access control to electrical charging stations or sockets is made possible which, supplemented by transfer session management, allows secure access and/or selective onward billing to the end user. Access control and session management are derived, respectively, from the authentication and authorization standards and from session management as it is known from webpage session management, in order to control and monitor activated energy transfer sessions. The disclosed method and arrangement can be installed globally, but also on a small scale in buildings or office complexes. The method can also be used for the dispensing/feeding-in of energy at a publicly accessible energy transfer facility. Electric vehicles can therefore provide battery power which is not needed at the present time into an energy network of an energy provider. By means of the access and authorization mechanism it is possible to ensure a dedicated accounting and payment arrangement for the respective producer or consumer. In principle the method can also be extended to the connection of the energy transfer unit to a plurality of providers.

According to a first embodiment, the consumer is authenticated and authorized at the energy access unit by means of a standard IT access control mechanism. Already existing or known access control mechanisms can therefore be used. Accordingly there is no need to develop new or proprietary access control mechanisms.

According to a further embodiment, PKI (Public Key Infrastructure) with smartcard is used as access control mechanism. Such mechanisms are known to a user and can be easily realized and installed.

According to a further embodiment, rules for the energy transfer are provided by the energy provider for the energy access unit. Such rules can be, for example: maximum draw-off or delivery volume per session or the energy quantity per time unit. Hoarding, for example, can be prevented in this way.

According to a further embodiment, the session token is updated by the energy access unit or the producer/consumer each time before being sent. This can be effected for example in that a counter is incremented each time before the session token is sent. The updating of the token increases the level of security against an unauthorized access (e.g. man-in-the-middle attack; MITM attack) to the energy transfer between producer/consumer and the energy access unit.

According to a further embodiment, the communication between the producer or consumer and the energy access unit takes place by means of power line communication (PLC), i.e. the transmission of data via power cables. In this case the power-conducting cables are utilized for transmitting data also, in parallel with the energy supply. Recourse can therefore be made to existing infrastructure.

According to a further embodiment, a local initial session token is generated by the energy access control unit and transmitted to the producer or consumer, the producer or consumer transmitting said initial session token to the energy provider, and the energy provider thereupon generating a session token for the corresponding energy access unit and the corresponding energy transfer and sending the same back to the producer or consumer, the initial session token containing identification information for the energy access unit and the session token containing the released energy quantity. As a result no direct internet connection is necessary between energy access unit (energy transfer point) and the energy provider for identification and authorization purposes. In addition, simple retrofitting is possible. Existing security provisions can be easily replaced by the energy access control unit as disclosed. Standard internet services can furthermore be used for billing transactions. The procedure for extending the (energy transfer) operation after a predefined time interval also conforms to the initial session token concept.

According to a further embodiment, the producer or consumer is an electric vehicle, and the energy access unit is a charging device for charging batteries or accumulators, or is suitable for feeding energy from electric vehicles into an energy grid of an energy provider. The trend in the automobile industry is toward providing the vehicle with more and more IT services and control instrumentation, such as navigation systems, adaptive speed control and safe-distance-maintaining mechanisms, etc. Implicit in the slogan car-to-car or car-to-X communication is the intention that vehicles will soon possess a permanent internet connection. Vehicles will in future be equipped with highly secure identification, authentication and signature functions, such that access control between vehicle and energy transfer point, as well as payment transactions, can be handled by way of the IT infrastructure present in the vehicle. The action radius of an electric vehicle will be very greatly increased as a result of the use of publicly accessible energy transfer points (e.g. public charging stations). The vehicle battery can also be used as an energy buffer for smart grids.

According to a further embodiment, the consumer can be a washing machine, a laundry dryer or another commercial electrical appliance. The disclosed method can be flexibly deployed and/or easily retrofitted, and can be used for dedicated access control for in principle all commercial electrical appliances.

According to a further embodiment, the producer is a photovoltaic system, a wind turbine or another alternative energy source which can be temporarily connected to the energy access unit. The method can therefore also be used for smart grids (intelligent power networks) through the temporary connection of decentralized energy producers and their feeding of electricity into an energy network.

According to a further embodiment, the energy transfer is stopped if the session token is not updated and exchanged between producer and consumer in the defined interval. This ensures that the energy transfer takes place between the identified and authorized units only, and the energy cannot be “tapped” by a third party.

According to a further embodiment, the session token is used to exchange dynamic demand or capacity information for monitoring and controlling the energy flow between producer or consumer and the energy access unit. The session token can therefore carry additional useful information.

The object is further achieved by means of an arrangement for access and session control of electrical producer and consumer devices at publicly accessible or communally accessible energy access units, said arrangement comprising:

a) an energy access unit disposed upstream of a conventional socket by means of which a consumer device can draw electrical energy or, as producer, can feed in energy, wherein the producer or consumer device is authenticated and authorized at the energy access unit by means of a standard IT access control mechanism, wherein, upon completion of authentication and authorization of the producer or consumer device, consumer-specific data is forwarded to an energy provider by the energy access unit, wherein electrical energy is transferred between the energy access unit and the producer or consumer device at the energy access unit as long as a session token provided by the energy provider is in each case sent at least once in a defined time interval from the energy access unit to the producer or consumer device, and from the producer or consumer device to the energy access unit; and
b) an energy provider which supplies the energy access unit with electrical energy or receives energy fed in by the producer device, wherein the energy provider, after successful authentication and authorization of the producer or consumer device, generates a session token and forwards the same to the energy access unit. Such arrangements can in principle be set up everywhere, such as in public car parks, since the energy access unit can be integrated into the electrical distribution box and the conventional socket installation can continue to be used.

The object is further achieved by means of an energy access control unit for access and session control of electrical consumer devices at publicly accessible or communally accessible energy access units by means of which a consumer device can draw electrical energy or a producer device can feed in energy, wherein the producer or consumer device is authenticated and authorized by the energy access control unit by means of a standard IT access control mechanism, wherein, upon completion of authentication and authorization of the producer or consumer device, consumer-specific data is forwarded to an energy provider by the energy access control unit, wherein electrical energy for the consumer device is provided at the energy access unit during a charging process or is fed in by the producer device as long as a session token provided by the energy provider is in each case sent at least once in a defined time interval from the energy access unit to the producer or consumer device, and from the producer or consumer device to the energy access unit. The disclosed energy access control unit can for example also be retrofitted without major effort or expenditure at publicly accessible sockets.

According to a further embodiment, a local initial session token is generated by the energy access control unit and transmitted to the producer or consumer, the producer or consumer transmitting said initial session token to the energy provider, and the energy provider thereupon generating a session token for the corresponding energy access unit and the corresponding energy transfer, and sending the same back to the producer or consumer, the initial session token containing identification information for the energy access unit and the session token containing the released energy quantity. As a result no direct internet connection between energy access unit (energy transfer point) and the energy provider is necessary for identification and authentication purposes. In addition, simple retrofitting is possible. Existing security provisions can easily be replaced by the disclosed energy access control unit. As well as this, payment transactions are possible by way of standard internet services.

The problem of communally used electrical charging stations or energy transfer stations is a relatively new problem for everyone, characterized by the boom in electric vehicles. Although it is true that there are already countless electrical sockets on buildings or at various locations, these cannot be used because the drawing of power cannot be selectively monitored and controlled and the costs cannot be passed on directly. In order to resolve the problem of monitoring and controlling access to electric supply lines it is proposed according to use an access concept which is based on the use of standard IT security measures and to use session tokens for monitoring the energy transfer session.

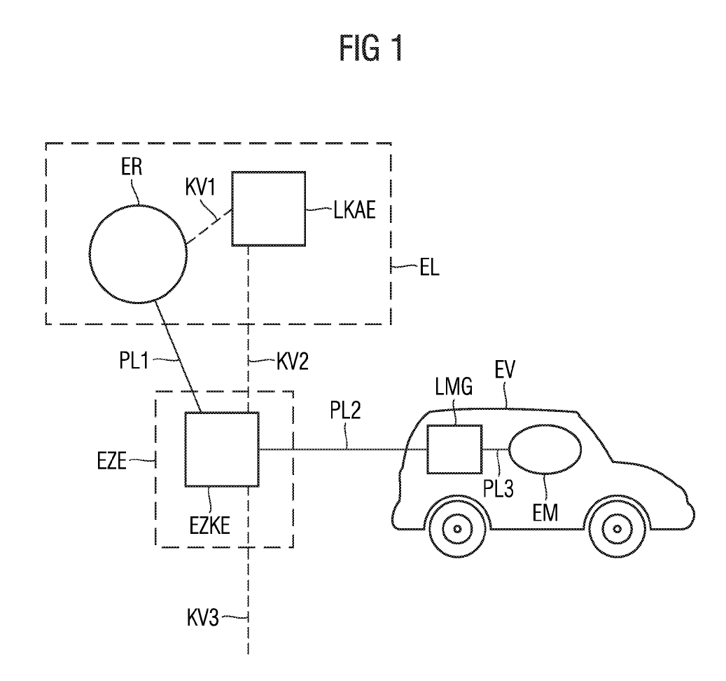

FIG. 1 shows by way of example a schematic overview diagram with system components as well as energy transfer and communication relationships between the system components. The main components in FIG. 1 are an energy provider EL, an energy access unit EZE (such as a charging station for electric vehicles or a station for feeding energy into a power grid of an energy provider) and an energy consumer EV (such as an electric vehicle). The energy consumer EV wishes to draw (tap) energy at the energy access unit EZE in order, for example, to charge up the rechargeable battery for an electric vehicle. The energy itself is then provided by an energy provider EL (such as an energy supply company). The energy consumer EV has a charging and metering device LMG by means of which it obtains current via a power line PL2 for example for charging a rechargeable battery of the energy access unit EZE. The current is provided to the energy access unit EZE by the energy provider EL via a power line PL1 from an energy resource ER belonging to the energy provider EL. The energy provider EL is equipped with a delivery control and accounting unit LKAE for controlling access to the energy resource pool and for billing for energy quantities which are provided for a session of the energy access unit EZE. This delivery control and accounting unit LKAE can be provided by the energy provider EL as, for example, a secure web service which provides as access control mechanisms e.g. standard security concepts such as PK1 with X.509 certificates. The dashed lines KV1 to KV3 represent communication links which can be realized as wire-based and/or wireless (for example by means of WLANs), and the communication links KV1-KV3 can be realized as internet connections. The energy access unit EZE contains an energy access control unit EZKE which handles the access control and access authorization of the energy consumer EV and, in addition, initiates an energy transfer session for a consumer via the communication link KV2. The delivery control and accounting unit LKAE at the energy provider EL initiates, via the communication link KV1, the provision of the energy from the energy resource pool ER for the required session via the power line PL1 at the energy access unit EZE. The energy consumer EV typically has an electric motor EM which is driven by the drawn energy. In FIG. 1 the electric motor EM is provided with the energy via the power line PL3 from the charging and metering device LMG after charging has been completed.

In principle the electric motor EM of a consumer EV can also function as a generator and provide energy which is made available to an energy provider EL by the energy access unit or energy transfer unit EZE. This is of interest for smart grid (intelligent power network) applications.

If the energy producer or consumer EV is an electric vehicle, the following tasks in particular ensue for the communication between vehicle and the energy access or transfer unit EZE:
detection of the vehicle (e.g. in order to assign the vehicle to an energy account of the vehicle owner at the energy provider EL)
detection of the charging system of the vehicle, and specification of which type of charging is to be carried out if several options are possible
detection of an error-free energy connection to the vehicle
starting and ending of the charging or feed-in operation.

The following tasks in particular ensure for the communication between energy access unit and energy transfer unit EZE:
billing for the power delivered
provision of the power required at the energy access or transfer unit EZE from the power network (energy reserve) ER of the provider
provision of the corresponding tariff for the producer/consumer EV
with vehicle-to-grid (V2G) systems (smart grids, intelligent power networks): feeding of the power from the vehicle battery into the network of the energy provider EL.

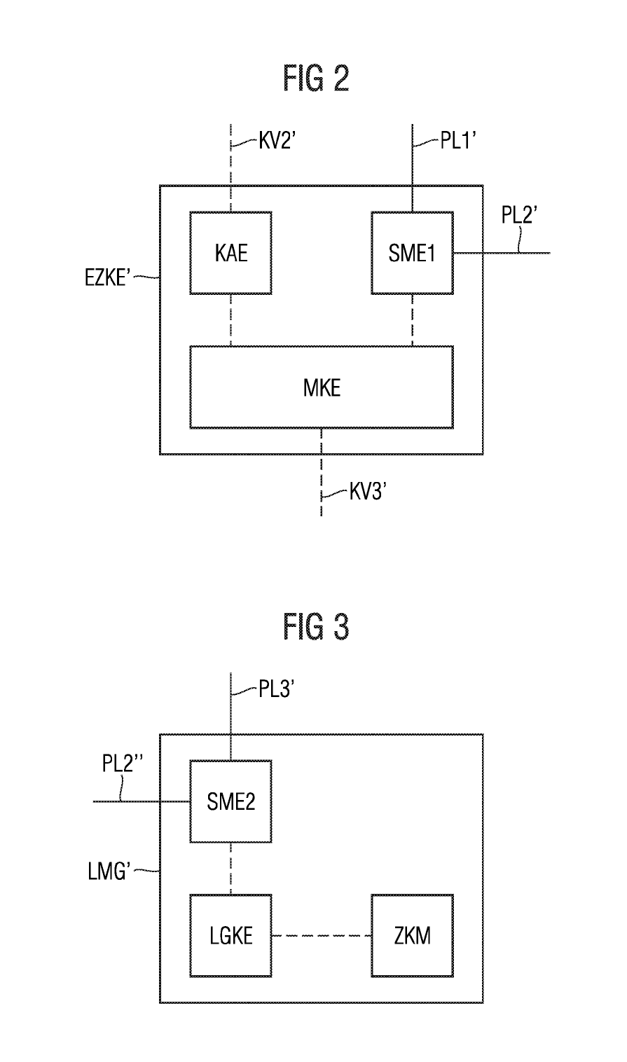

FIG. 2 shows by way of example a schematic diagram of an energy access control unit EZKE. The energy access control unit EZKE is equipped with an energy counter (an energy counter such as is installed at customer premises by an energy provider, for example), but offers a special additional functionality in order to permit access to third-party consumers and to handle the billing for the energy drawn to their account. The energy access control unit EZKE′ comprises a remote control accounting unit FKAE, a current sensor modulator unit SME1, and a management and control unit MKE.

The remote control and accounting unit FKAE sets up a secure internet connection as necessary to the energy provider EL in order to exchange with the latter information for access control and billing. The current sensor modulator unit SME1 is both a current modulator (over the entire power range) and a current measuring device or meter. Accordingly this unit can limit the current on the one hand and it replaces a security cutout or the current intensity could also be measured by the sensor. As well as the switching of the current, this functionality is also used as a communication mechanism with the charging and metering device LMG of the energy consumer EV. The management and control unit MKE controls the entire execution sequence of the energy access control unit EZKE′ and provides the local user interface and the interface into local networks, for example to the building management. This interface is formed by the communication link KV3′.

FIG. 3 shows by way of example a schematic diagram of a charging and metering device LMG′. Each participant (energy producer or energy consumer EV) wanting to load or feed in energy must be equipped with a charging and metering device LMG′. In electric vehicles said charging and metering device LMG′ can be referred to as an onboard charging and metering device (OBCM). The charging and metering device LMG′ controls access to an electrical socket or to a charging station by corresponding authentication and authorization, and maintains the connection for as long as there exists a demand for energy transfer. The current sensor modulator unit SME2 is the counterpart to the energy access control unit EZKE of the energy access or energy transfer unit EZE. The current sensor modulator unit SME2 permits the monitoring and control of the load resistance and consequently the adjustment of the current intensity, which is used on the one hand for communication and on the other hand for adjusting the charging current intensity. The charging and generator control unit LGKE monitors the information sent via the power line PL2″ or, alternatively, controls the energy transfer to the energy consumer EV in accordance with the energy utilization profile. The access control module ZKM contains the interface to the security medium for authentication and authorization, which could be a SIM card or a smartcard, for example.

### Description of the Execution Sequence:

If an external electrical socket on a building is equipped internally in the distribution cabinet with an energy access control unit EZKE, for example instead of the combination of counter and security cutout, then upon connection this socket, if not configured manually for continuous operation, outputs only a low current intensity (4 to 20 mA, for example). Said current intensity cannot really be misused for the energy transfer, but will be interpreted and detected by a corresponding charging and metering device LMG. Following detection, the current intensity, modulated at 4 to 20 mA, is used for the coded data transmission between energy consumer or producer EV and energy access control unit EZKE. The data transmission always takes place asynchronously; first the energy access control unit EZKE sends, and the charging and metering device LMS is in receiving mode, and then the direction is reversed. This amplitude-modeled method is a robust possibility of transmitting binary signals over power lines, without encountering problems with overvoltage or surge arresters or in interference filters. Other possible embodiment variants are methods at a higher up-modulated frequency (such as frequency- or phase-modulated methods).

Data is transmitted by means of an error-redundant protocol in both directions between the energy consumer EV and the energy access unit EZE. In this case it is sufficient for the current to flow always in only one direction, and for the charging and metering device LMG to keep the resistance constant during the reception, while during sending it must change the internal resistance.

Based on this data transfer (comparable with the Data Link layer in communications technology, ISO-secure reference model), standard authentication and authorization protocol data (such as SAML (Security Assertion Markup Language)) is transmitted to the remote control and accounting unit FKAE of the energy access control unit EZKE, which forwards said data by IP protocol to the service on the provider side (i.e. on the side of the energy provider EL) to the delivery control and accounting unit LKAE. If the access control is successful, a session token is generated by the delivery control and accounting unit LKAE and supplied to the energy access control unit EZKE.

With this token, the energy supply session between the energy access unit EZE and the energy consumer or producer EV becomes active and runs with a typical timeout of, for example, 1 to 5 minutes. This means that the remote control and accounting unit FKAE delivers, once a minute, a message with the session token and the energy value for billing to the consumer. This session token is also transmitted over the power line PL2, PL2′ to the charging and metering device LMG, LMG′. Simultaneously with the session token, the energy quantity supplied thus far is also sent. Accordingly the charging and metering device LMG, LMG′ also has the possibility of determining whether said energy quantity has in fact arrived, and can rapidly detect problems with branching or faults to ground and terminate the transfer. The charging and metering device LMG, LMG′ must also sign in with this session token at least once in the session timeout interval, since in the absence of timely sign-in the transfer session will be stopped and consequently the current and energy flow simply ended. It is therefore assured that in the event of unplugging and reconnecting after the approved access, the energy quantity for a session timeout will be transferred at a maximum.

The costs for a charge are not billed to the owner of the socket unit, but can be invoiced directly to the end consumer EV; similarly, credit notes for an energy feed-in can be issued directly to an energy producer. The access control to the energy access units EZE (such as charging stations for electric vehicles) is therefore practically at the same standard as current IT access control standards such as PKI with smartcards. Thanks to the use of smartcards there is also no need for the access control and billing to be implemented directly on the device, but instead it can remain tied in a flexible manner to the card.

An access control to electrical charging stations or sockets may be provided that, supplemented by transfer session management, enables secure access or selective onward billing to the end user. Access control and session management are derived, respectively, from authentication and authorization standards and session management as is known from webpage session management in order to monitor and control activated energy transfer sessions. The disclosed method and arrangement can be installed globally, but also on a small scale in buildings or office complexes. An advantage may also lie in the fact that simple sockets can be provided in public facilities or communal areas such that every electricity customer can charge up electric vehicles, for example, at said locations, and billing then takes place automatically, while misuse of the charging station becomes practically impossible. Retrofitting is possible with simple units which replace security cutouts and counters in distribution boxes. Newly installed electrical energy filling stations can also be equipped with the same concept in order to enable savings to be made on the costs of complicated and expensive service and billing terminals.

Certain embodiments provide solution concepts for the following subsidiary problems in particular:

### Subsidiary Problem 1: Lack of Multi-Party Access and Billing Concept for Existing Sockets

There are already countless sockets available on buildings and in various other locations, but these cannot be used because the drawn-off energy cannot be selectively monitored and controlled, and costs cannot be directly passed on. It must be prevented for example that someone pulls the electrical connector and in the interim can insert another one. Because electric vehicles consume relatively large amounts of energy, freely accessible sockets will soon be secured in order to prevent misuse. If sockets are equipped with automatic authorization and billing to the user, or possibly a fee could be paid to the socket provider, that would increase the availability of charging stations much more rapidly and therefore also the regional coverage of charging possibilities for an electric vehicle would be substantially improved.

### Subsidiary Problem 2: Manual Access Control to Charging Stations

An energy dispenser which is to be operated in a similar manner to an automatic teller machine on the one hand requires an operator terminal for access control and billing. Because electric vehicles must be charged much more often than today's vehicles with combustion engines need refueling, or are also intended to serve as energy buffers, this concept of concentrated access to energy and billing does not stand up. Charging stations at which, as in the case of a fuel filling station, first a credit card is inserted and then the fuel tank is filled, require very expensive operator terminals on the one hand, and on the other hand this will be too complicated for the future, particularly because electric vehicles must be charged up substantially more often than is the case at present with vehicles with combustion engines, or because the electric vehicles must often be charged or deliver current automatically on a time-controlled basis (for example in garages or car parks). By means of the session token concept it can be ensured that only the authenticated and authorized device is charged. If the connector is pulled in the meantime and another device connected, this device will be provided with energy at a maximum up until the timeout, since this device cannot know the valid temporary session token.

### Subsidiary Problem 3: Retrofitting of Legacy Systems in the Home and Residential Environment

Selective billing of energy in communally accessible areas will become much more important than it is today. At present, the selective energy demand is combined with the use of the resource. For example, there are access control systems for laundry dryers or washing machines. The user pays for the entire use. However, if users now have electrically assisted bicycles, mopeds or cars, this is no longer possible and an access control to electrical energy must be provided, together with recording and billing of the quantities dispensed. Retrofitting with the two control units on the provider side and the user side would be very simple and economical if these elements were available as standardware. For new installations, these elements could replace energy counters and security cutouts in combination on the provider side if a separate connecting line is used for each socket. Accordingly, practically every socket would be configurable, and simple access control and billing could be realized. The disclosed method can also be used in communal areas, such as, for example, for the billing of washing machines, heat dryers or hot water storage heaters. In underground carparks, too, charging stations can be very easily equipped with the disclosed method.

Method for access and session control of electrical producers and/or consumers in publicly accessible or communally accessible energy transfer units, wherein the producer or the consumer is authenticated and authorized at the energy transfer unit and, upon completion of authentication and authorization of the producer or the consumer, producer- or consumer-specific data is forwarded to an energy provider via the energy transfer unit. This is followed by the generation of a session token for the monitoring and control of the energy transfer by the energy provider and forwarding of the session token to the energy transfer unit and the producer or consumer, wherein the session token has a time-limited validity. Transfer of electrical energy between the energy transfer unit and the producer or consumer, wherein the session token is in each case sent at least once in a defined time interval from the energy transfer unit to the producer or consumer, and from the producer or consumer to the energy transfer unit. The method allows in particular a simple and retrofittable control of access to freely accessible sockets and public charging stations which can be used in the future by electric vehicles. In addition, the method enables a simple and retrofittable access control of decentralized (private and commercial) energy producers on smart grid networks. For example, electric vehicles can also feed in battery power not required during times of non-use (vehicle-to-grid (V2G) systems).

### REFERENCE SIGNS

EL Energy provider
ER Energy resource
LKAE Delivery control and accounting unit
KV1-KV3, KV3′ Communication link
PL1-PL3, PL1′-PL3′ Power line
PL2″ Power line
EZE Energy access unit
EZKE, EZKE′ Energy access control unit
EV Energy consumer or producer
EM Electric motor
LMG, LMG′ Charging and metering device
MKE Management and control unit
SME1, SME2 Current sensor modulator unit
FKAE Remote control and accounting unit
ZKM Access control module
LGKE Charging and generator control unit

What is claimed is:

1. A method for access and session control of electrical producers and/or consumers at publicly accessible or communally accessible energy access or transfer units, said method comprising:
a) authenticating and authorizing the producer or consumer at the energy access unit by data exchange between the energy access unit and an energy provider;
b) generating a session token for the monitoring and control of an energy transfer by the energy provider and forwarding of the session token to the energy access unit and the producer or consumer, the session token having a time-limited validity;
c) after successful authentication and authorization of the producer or consumer, forwarding of producer-specific or consumer-specific data to an energy provider by the energy access unit; and
d) transferring electrical energy between the energy access unit and the producer or consumer, the session token being in each case sent in a defined time interval during the energy transfer process at least once from the energy access unit to the producer or consumer, and from the producer or consumer to the energy access unit.

2. The method of claim 1, wherein the consumer is authenticated and authorized at the energy access unit by a standard IT access control mechanism.

3. The method of claim 2, wherein PKI (public key infrastructure) with smartcard is used as the access control mechanism.

4. The method of claim 1, wherein rules for the energy transfer are provided for the energy access unit by the energy provider.

5. The method of claim 1, wherein each time before being sent the session token is updated by the energy access unit or by the producer/consumer.

6. The method of claim 1, wherein the communication between the producer or consumer and the energy access unit takes place by power line communication.

7. The method of claim 1, wherein a local initial session token is generated by the energy access control unit and transmitted to the producer or consumer, the producer or consumer transmitting said initial session token to the energy provider, and the energy provider thereupon generating a session token for the corresponding energy access unit and the corresponding energy transfer and sending the same back to the producer or consumer, the initial session token containing identification information for the energy access unit and the session token containing the released energy quantity.

8. The method of claim 1, wherein the producer or consumer is an electric vehicle and the energy access unit is a charging device for charging batteries or accumulators or is suitable for feeding energy from electric vehicles into an energy network of an energy provider.

9. The method of claim 1, wherein the consumer is a washing machine, a laundry dryer or another commercial electrical appliance.

10. The method of claim 1, wherein the producer is a photovoltaic system, a wind turbine or another alternative energy source which can be temporarily connected to the energy access unit.

11. The method of claim 1, wherein the energy transfer is stopped if the session token is not updated and exchanged between producer and consumer in the defined interval.

12. The method of claim 1, wherein the session token is used to exchange dynamic demand or capacity information for the monitoring and control of the energy flow between producer or consumer and the energy access unit.

13. An arrangement for access and session control of electrical producer or consumer devices at publicly accessible or communally accessible sockets with upstream energy access units, said arrangement comprising:
a) an energy access unit configured to provide a producer or a consumer device access to draw or feed electrical energy,
wherein authentication and authorization of the producer or consumer device takes place at the energy access unit by a standard IT access control mechanism and IT services,
wherein following completion of authentication and authorization of the producer or consumer device, consumer-specific data is forwarded to an energy provider by the energy access unit,
wherein electrical energy is transferred between the energy access unit and the producer or consumer device at the energy access unit as long as a session token provided by the energy provider is sent at least once in a defined time interval from the energy access unit to the producer or consumer device, and from the producer or consumer device to the energy access unit;
b) an energy provider that supplies the energy access unit with electrical energy or receives energy fed in by the producer device,
wherein the energy provider, after successful authentication and authorization of the producer or consumer device, generates a session token and forwards the same to the energy access unit.

14. An energy access control unit for access and session control of electrical producer or consumer devices at publicly accessible or communally accessible energy access units configured to provide a producer device or a consumer device access to draw or feed electrical energy;
wherein authentication and authorization of the consumer device by the energy access unit takes place by a standard IT access control mechanism,
wherein upon completion of authentication and authorization of the producer or consumer device by the energy access control unit, consumer-specific data is forwarded to an energy provider,
wherein, during a charging process, electrical energy for the consumer device is provided at the energy access unit or is fed in by the producer device as long as a session token provided by the energy provider is in each case sent at least once in a defined time interval from the energy access control unit to the producer or consumer device, and from the producer or consumer device to the energy access control unit.

15. The energy access control unit as claimed in claim 14, wherein:
a local initial session token is generated by the energy access control unit and transmitted to the producer or consumer,
the producer or consumer forwards said initial session token to the energy provider and the energy provider thereupon generates a session token for the corresponding energy access unit and the corresponding energy transfer, and sends the same back to the producer or consumer, and
wherein the initial session token contains identification information for the energy access unit and the session token contains the released energy quantity.
